(19) United States
(12) Patent Application Publication
(10) Pub. No.: US 2010/0026012 A1
(43) Pub. Date: Feb. 4, 2010

(54) Press bar mechanism

(75) Inventor: Ching Tien Lin, Taipei Hsien (TW)

Correspondence Address: CHARLES E. BAXLEY, ESQUIRE, 90 JOHN STREET, SUITE 309, NEW YORK, NY, 10038, US

(73) Assignee: Thase Enterprise Co., Ltd.

(21) Appl. No.: 12/220,999

(22) Filed: Jul. 30, 2008

(51) Int. Cl. E05B 65/10

(52) U.S. Cl. 292/92

(57) ABSTRACT

A press bar mechanism includes a latch bolt slidably attached to a housing, a pressing bar slidably attached to the housing and coupled to the latch bolt, a rod slidably received in the housing and coupled to the latch bolt, a casing disposed in the housing and having a compartment for receiving a spring member and a follower and having a helical groove communicating with the compartment of the casing, a guide pin secured to the follower and engaged in the helical groove of the casing for cushioning the movement of the follower relative to the casing and also for cushioning the pressing bar and for preventing the press bar from generating sounds or noises.

### BACKGROUND OF THE INVENTION

1. Field of the Invention

The present invention relates to a press bar mechanism for an emergency escape or exit door or fire retardant door and exit device, and more particularly to a press bar mechanism including a buffering or cushioning or damping device for cushioning or damping the movement of the press bar and for preventing the press bar from generating sounds or noises.

2. Description of the Prior Art

Typical emergency escape or exit doors or fire retardant doors and exit devices comprise a press bar mechanism for being actuated by the user to open the emergency escape or exit door or fire retardant door.

For example, U.S. Pat. No. 5,816,017 to Hunt et al., U.S. Pat. No. 6,000,733 Linder, and U.S. Pat. No. 6,945,571 to Lin disclose three of the typical press bar devices or mechanisms each comprising a press bar carried on a door panel, and coupled to a latch bolt with a crank-coupling mechanism, and/or one or more sliding members, for allowing the press bar to selectively actuate or operate the latch bolt to release or to lock or to unlock the emergency escape or exit doors or fire retardant doors and exit devices.

However, normally, no buffering or cushioning or damping devices or mechanisms have been provided and disposed between the press bar and the emergency escape or exit door, and the press bar may have a good chance to strike onto the emergency escape or exit door and to make or generate sounds or noises when the press bar is released by the user.

The present invention has arisen to mitigate and/or obviate the afore-described disadvantages of the conventional press bar devices or mechanisms for the emergency escape or exit doors or fire retardant doors and exit devices.

### SUMMARY OF THE INVENTION

The primary objective of the present invention is to provide a press bar mechanism including a buffering or cushioning or damping device for cushioning or damping the movement of the press bar and for preventing the press bar from generating sounds or noises.

In accordance with one aspect of the invention, there is provided a press bar mechanism comprising a housing, a latch bolt slidably attached to the housing, a pressing bar slidably attached to the housing and movable toward the housing and coupled to the latch bolt for selectively retracting the latch bolt into the housing, a rod slidably received in the housing and coupled to the latch bolt for selectively retracting the latch bolt into the housing, and including an extension extended therefrom, a casing disposed in the housing, and including a compartment formed therein, and including a helical groove formed therein and communicating with the compartment of the casing, a follower slidably and rotatably received in the compartment of the casing and extendible out of the compartment of the casing, a guide pin secured to the follower and slidably received and engaged in the helical groove of the casing for guiding the follower to move axially and rotatably relative to the casing by a sliding movement of the guide pin in the helical groove of the casing, and a spring biasing device for biasing the follower to move out of the compartment of the casing, and the extension of the rod being moved away from the follower when the pressing bar is depressed and moved toward the housing, and the extension of the rod being forced to engage with the follower and to force the follower into the compartment of the casing when the pressing bar is released.

The housing includes a bracket disposed and secured therein, and the casing is secured to the bracket. The bracket includes a chamber formed therein and defined between two side walls for receiving the casing.

The bracket includes a notch formed in one of the side walls, and the casing includes a catch extended outwardly therefrom and engaged with the notch of the side wall for anchoring the casing to the bracket and the housing.

The biasing device includes a spring member received in the compartment of the casing. The casing includes a seat slidably received in the compartment of the casing and engaged with the spring member and attached to the follower.

The follower includes a cavity formed therein, and the seat includes a projection extended outwardly therefrom and engaged into the cavity of the follower. The guide pin includes a roller attached to a free end portion thereof and slidably received and engaged in the helical groove of the casing.

The housing includes a frame disposed and secured therein, and a crank pivotally coupled to the frame and the housing 10 with a pivot axle and pivotally coupled to the latch bolt with a link and pivotally coupled to the pressing bar.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view of a press bar mechanism in accordance with the present invention;

FIG. 2 is a partial cross sectional view similar to FIG. 1, illustrating the operation of the press bar mechanism;

FIG. 3 is a partial exploded view illustrating a portion of the press bar mechanism;

FIG. 4 is a perspective view illustrating the portion of the press bar mechanism as shown in FIG. 3; and

FIGS. 5, 6 are perspective views similar to FIG. 4, in which a portion of the press bar mechanism has been cut off for showing an inner structure of the press bar mechanism.

### DETAILED DESCRIPTION OF THE PREFERRED EMBODIMENT

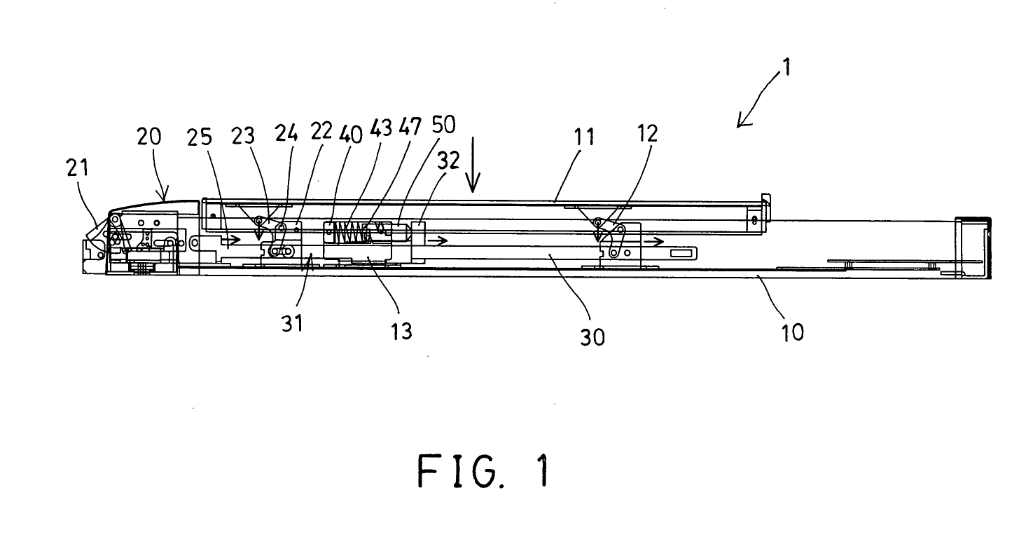

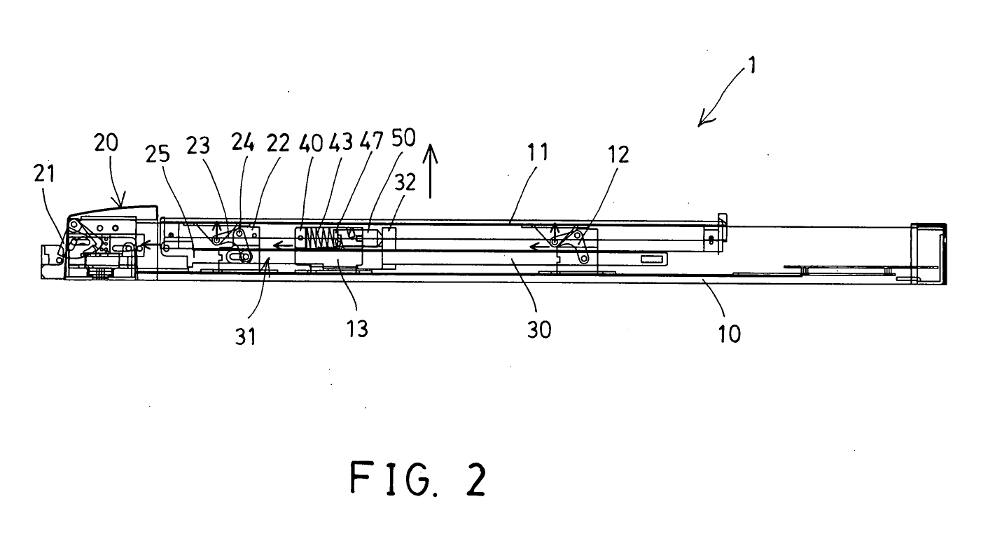

Referring to the drawings, and initially to FIGS. 1 and 2, a press bar mechanism 1 in accordance with the present invention comprises a base or housing 10 for attaching to an emergency escape door or fire retardant door and exit device or exit door panel (not shown), and a pressing bar 11 slidably attached to the housing 10 and movable or depressible toward the housing 10 for being selectively depressed or actuated by the user, and one or more spring members 12 disposed or attached between the pressing bar 11 and the exit door panel for biasing or forcing the pressing bar 11 away from the exit door panel and the housing 10 when the pressing bar 11 is released by the user.

A lock device 20 is attached to the housing 10 and includes a latch bolt 21 for selectively releasing or locking or unlocking the exit door panel, and includes a frame 22 disposed or attached or secured to the housing 10, a crank 23 rotatably or pivotally coupled to the frame 22 or the housing 10 with a pivot axle 24 and pivotally coupled to the latch bolt 21 with a link 25 and also pivotally coupled to the pressing bar 11 for allowing the latch bolt 21 to be selectively moved or retracted into the housing 10 when the pressing bar 11 is depressed toward the housing 10 by the user, and for allowing the exit door panel to be selectively opened. The above-described structure or arrangement is typical and will not be described in further details.

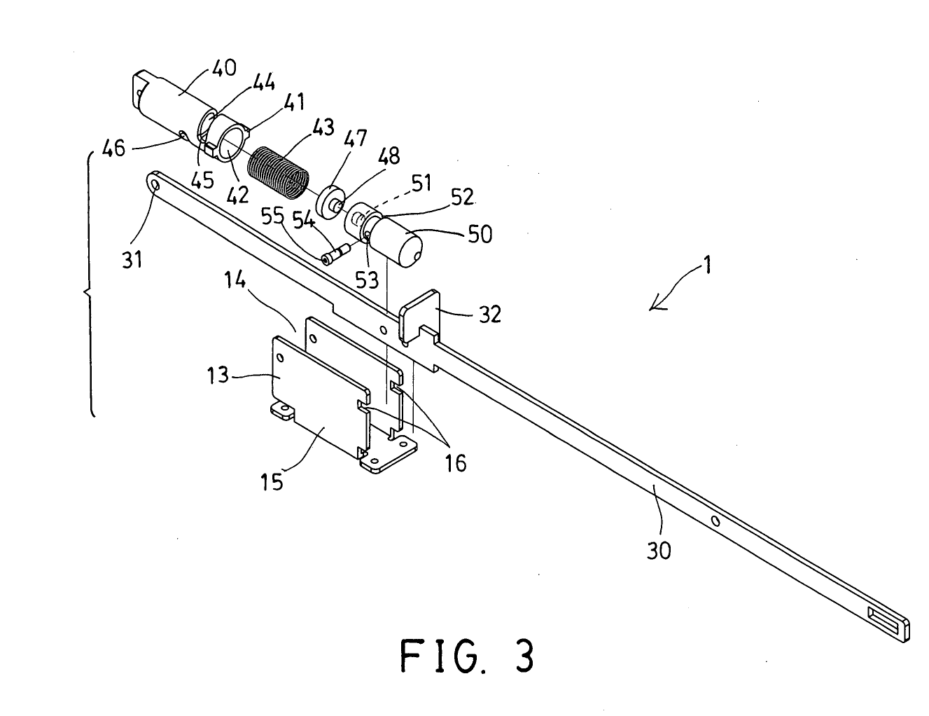

As shown in FIGS. 1-6, the press bar mechanism 1 further includes a support or bracket 13 disposed or attached or secured to the housing 10, and the bracket 13 includes a space or chamber 14 formed therein and formed or defined between two side walls 15, and a notch 16 formed in each of the side walls 15, a longitudinal beam or rod 30 is slidably received in the chamber 14 of the bracket 13 and also slidably received in the housing 10, and includes one end 31 pivotally coupled to the crank 23 and/or the link 25 and/or the latch bolt 21 to selectively move or retract the latch bolt 21 into the housing 10, and includes a stop or plate or extension 32 extended radially from the rod 30.

A casing 40 is disposed or received in the chamber 14 of the bracket 13 and includes one or more (such as two) catches 41 extended outwardly therefrom for engaging with the notches 16 of the side walls 15 of the bracket 13 and for anchoring or securing the casing 40 to the bracket 13 and/or the housing 10, and includes a bore or compartment 42 formed therein for slidably receiving a spring member 43 therein, and includes a helical groove 44 formed therein and communicating with the compartment 42 of the casing 40 and having two ends 45, 46. A seat 47 is also slidably received in the compartment 42 of the casing 40 and contacted or engaged with the spring member 43, and includes a projection 48 extended outwardly therefrom.

A latching member or follower 50 is slidably and rotatably received in the compartment 42 of the casing 40, and includes a cavity 51 formed in one end portion thereof for receiving the projection 48 of the seat 47 and for allowing the follower 50 to be secured to the seat 47 and to be moved in concert with the seat 47, and for allowing the seat 47 and the follower 50 to be biased and moved relative to the casing 40 by the spring member 43, and includes a peripheral recess 52 formed in the outer peripheral portion thereof, and the follower 50 further includes an orifice 53 formed therein and communicating with the peripheral recess 52 of the follower 50.

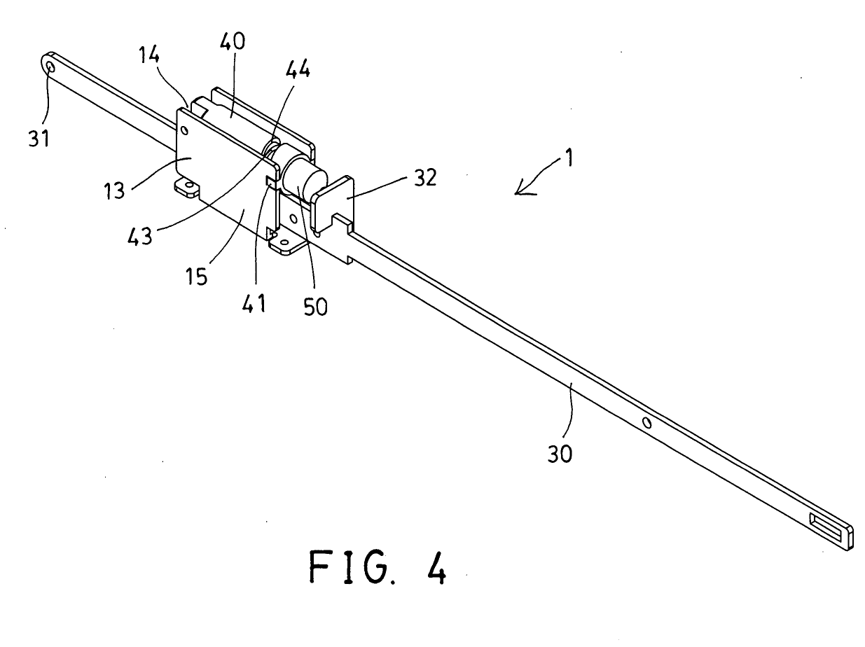

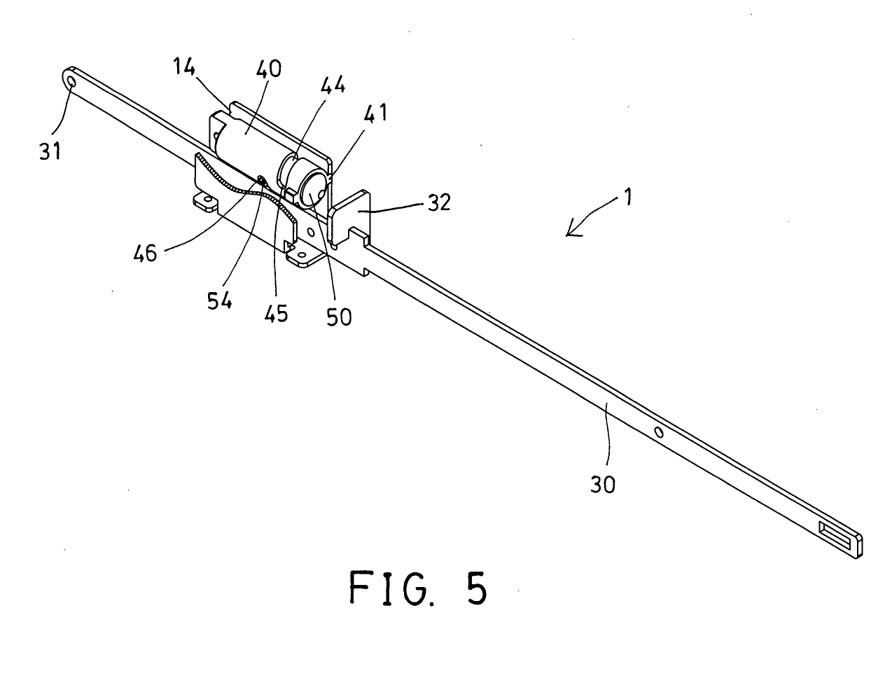

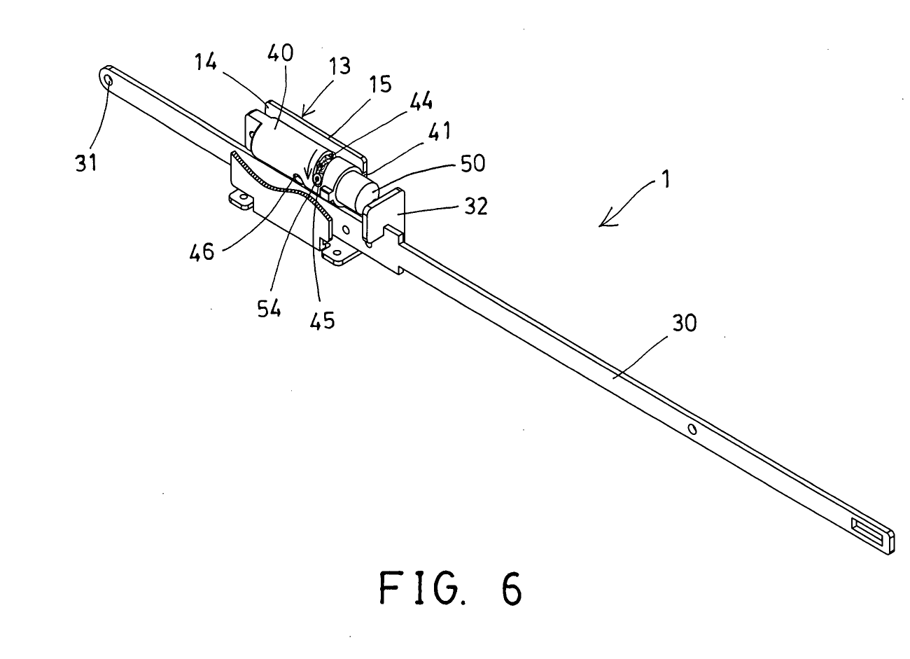

A guide pin 54 includes one end engaged into the orifice 53 of the follower 50 and secured to the follower 50 and to be moved in concert with the follower 50, and preferably includes a bearing or roller 55 attached to the free end portion thereof and slidably received and engaged in the helical groove 44 of the casing 40 and engageable with the ends 45, 46 of the helical groove 44 of the casing 40 (FIGS. 5, 6) and for allowing the follower 50 to be moved longitudinally or axially and rotatably relative to the casing 40 by the sliding movement of the guide pin 54 in and along the helical groove 44 of the casing 40 (FIGS. 4-6), and thus for damping or buffering or cushioning or slowing the movement of the follower 50 relative to the casing 40 and thus for damping or buffering or cushioning or slowing the movement of the rod 30 and the latch bolt 21 relative to the housing 10.

In operation, as shown in FIG. 1, when the pressing bar 11 is selectively depressed or actuated by the user and moved toward the housing 10, the latch bolt 21 may be selectively moved or retracted into the housing 10 by the crank 23, and simultaneously, the rod 30 may be selectively moved away from the lock device 20 by the crank 23, and the extension 32 of the rod 30 may be moved away from the follower 50. At this moment, the follower 50 may be moved or forced or biased to move out of the compartment 42 of the casing 40 slowly by the spring member 43 and by the sliding movement of the guide pin 54 in and along the helical groove 44 of the casing 40.

When the pressing bar 11 is released by the user, as shown in FIG. 2, the pressing bar 11 may be moved or forced or biased away from the exit door panel and the housing 10 by the spring members 12, and the latch bolt 21 may be moved or forced out of the housing 10 to engage with the exit door panel and to lock the exit door panel. At this moment, the extension 32 of the rod 30 may be moved or forced or biased to engage with the follower 50, and the follower 50 may be moved or forced onto the spring member 43 and to compress the spring member 43 such that the spring member 43 may be provided for buffering or cushioning or damping or slowing the movement of the press bar and for preventing the press bar 11 from generating sounds or noises. The spring member 43 may act as a spring biasing means for biasing the follower 50 out of the compartment 42 of the casing 40.

Accordingly, the press bar mechanism in accordance with the present invention includes a buffering or cushioning or damping device for cushioning or damping or slowing the movement of the press bar and for preventing the press bar from generating sounds or noises.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A press bar mechanism comprising:
a housing,
a latch bolt slidably attached to said housing,
a pressing bar slidably attached to said housing and movable toward said housing and coupled to said latch bolt for selectively retracting said latch bolt into said housing,
a rod slidably received in said housing and coupled to said latch bolt for selectively retracting said latch bolt into said housing, and including an extension extended therefrom,
a casing disposed in said housing, and including a compartment formed therein, and including a helical groove formed therein and communicating with said compartment of said casing,
a follower slidably and rotatably received in said compartment of said casing and extendible out of said compartment of said casing,
a guide pin secured to said follower and slidably received and engaged in said helical groove of said casing for guiding said follower to move axially and rotatably relative to said casing by a sliding movement of said guide pin in said helical groove of said casing, and
means for biasing said follower to move out of said compartment of said casing, and
said extension of said rod being moved away from said follower when said pressing bar is depressed and moved toward said housing, and said extension of said rod being forced to engage with said follower and to force said follower into said compartment of said casing when said pressing bar is released.

2. The press bar mechanism as claimed in claim 1, wherein said housing includes a bracket disposed and secured therein, and said casing is secured to said bracket.

3. The press bar mechanism as claimed in claim 2, wherein said bracket includes a chamber formed therein and defined between two side walls for receiving said casing.

4. The press bar mechanism as claimed in claim 3, wherein said bracket includes a notch formed in one of said side walls, and said casing includes a catch extended outwardly therefrom and engaged with said notch of said side wall for anchoring said casing to said bracket and said housing.

5. The press bar mechanism as claimed in claim 1, wherein said guide pin includes a roller attached to a free end portion thereof and slidably received and engaged in said helical groove of said casing.

6. The press bar mechanism as claimed in claim 1, wherein said biasing means includes a spring member received in said compartment of said casing.

7. The press bar mechanism as claimed in claim 6, wherein said casing includes a seat slidably received in said compartment of said casing and engaged with said spring member and attached to said follower.

8. The press bar mechanism as claimed in claim 7, wherein said follower includes a cavity formed therein, and said seat includes a projection extended outwardly therefrom and engaged into said cavity of said follower.

9. The press bar mechanism as claimed in claim 1, wherein said housing includes a frame disposed and secured therein, and a crank pivotally coupled to said frame and said housing 10 with a pivot axle and pivotally coupled to said latch bolt with a link and pivotally coupled to said pressing bar.
